(19) United States
(12) Patent Application Publication
(10) Pub. No.: US 2008/0039161 A1
(43) Pub. Date: Feb. 14, 2008

(54) CASING DEVICE FOR MOBILE HANDSET

(76) Inventor: Shih-Yang CHAN, Tu Cheng City (TW)

Correspondence Address: LEONG C LEI, PMB # 1008, 1867 YGNACIO VALLEY ROAD, WALNUT CREEK, CA, 94598, US

(21) Appl. No.: 11/420,488

(22) Filed: May 26, 2006

(51) Int. Cl. H04M 1/00

(52) U.S. Cl. 455/575.8

(57) ABSTRACT

A casing device for mobile handsets is provided. The casing device is made of a fine ceramics material molded into a single piece. The casing device has fastening elements so as to be joined to the body of a mobile handset. A plastic film can be coated or adhered to the inner surface of the casing device for enhancing the casing device's structural strength and its robustness to external impact.

### BACKGROUND OF THE INVENTION

(a) Technical Field of the Invention

The present invention generally relates to casing devices, and more particularly to a casing device made of a fine ceramics material specifically for mobile handsets.

(b) Description of the Prior Art

Mobile handsets or cellular phones have become indispensable accessories in people's daily life as the advancement of wireless communications has offered unparalleled convenience and mobility. The mobile handsets therefore have evolved from simple communications devices to fashionable items as demands continuously driving the industry for handsets with more appealing styles and appearances.

Conventionally, most mobile handsets have plastic or metallic cases molded into various shapes and colored by spray painting or japanning. The plastic cases, with inferior hardiness, suffer scratches and smudges after a period of usage. On the other hand, the japanning coating on the metallic cases would also peel off after a period of usage or under external impact.

### SUMMARY OF THE INVENTION

The primary purpose of the present invention is to provide a casing device for mobile handsets. The casing device is made of a ceramics material molded into a single piece. The casing device has fastening elements so as to be joined to the body of a mobile handset. A plastic film can be coated or adhered to the inner surface of the casing device for enhancing the casing device's structural strength and its robustness to external impact.

The present invention has a number of advantages. First, the fine ceramics material can have various colors and the color won't fade away after a period of usage. Secondly, the fine ceramics material offers superior hardness and smoothness to withstand scratches, abrasion, and smears. The casing device therefore can still look like new even after extended period of usage. The casing device can be all or part of the enclosure of a mobile handset. The casing device can also be made into a replaceable one so that a user can pick a suitable one for his or her handset.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a casing device according to an embodiment of the present invention and a mobile handset to which the casing device is affixed.

FIG. 2 is a perspective diagram showing the assembly of the casing device and the mobile handset of FIG 1.

FIG. 3 is a cross-sectional diagram of the casing device along the 3-3 line of FIG. 2.

FIG. 4 is a perspective diagram showing the inner side of the casing device of FIG. 1.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

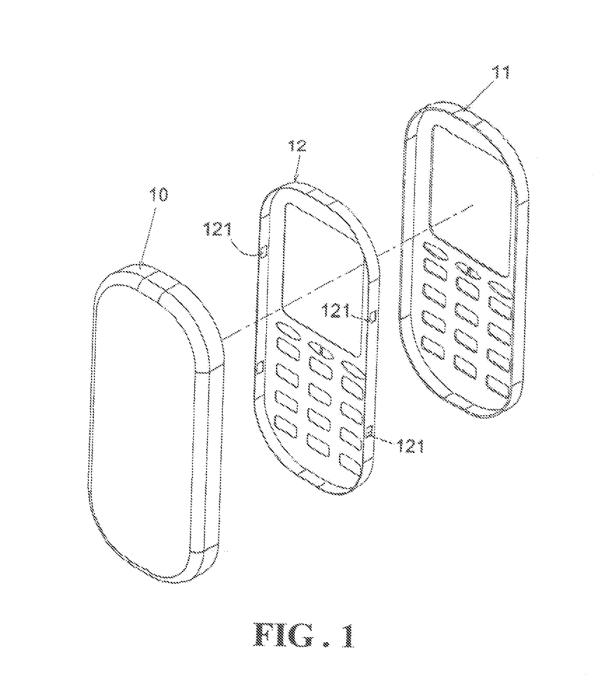

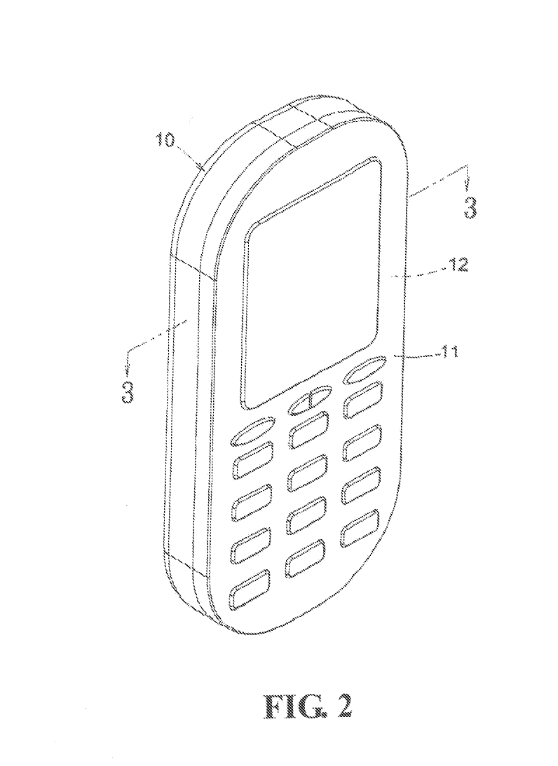

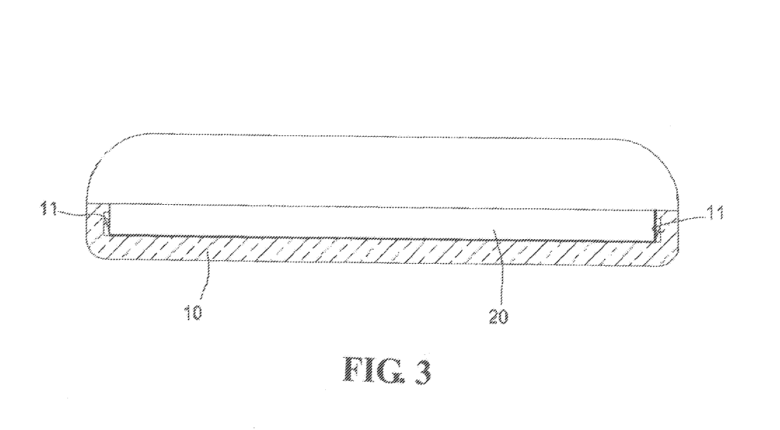

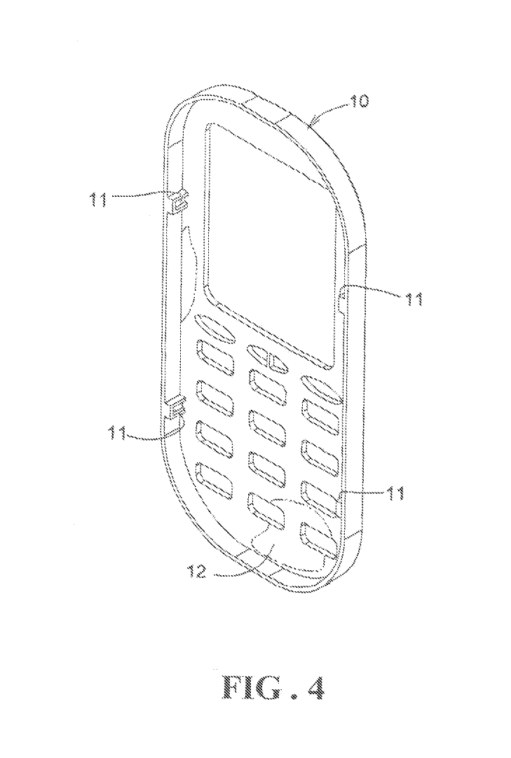

As shown in FIGS. 1 to 4, a casing device for mobile handsets is provided. The casing device 10 is made of a fine ceramics material such as zirconia molded into a single piece. Please note that, in alternative embodiments, other appropriate ceramics materials can also be used.

The casing device 10 has fastening elements 11 along its inner surface (i.e., the surface facing the mobile handset 20) so as to be joined to the corresponding fastening elements on the body of a mobile handset 20. As such the casing device 10 can be reliably attached to the mobile handset 20. The casing device 10 as described can function as the entire enclosure to the mobile handset 20 (i.e., enclosing the mobile handset 20 entirely), or it can be a part of the enclosure to the mobile handset 20 (i.e., enclosing a part of the body of the mobile handset 20 such as its front surface).

The locations and styles of the fastening elements 11 are not limited to those shown in the diagrams. For example, the fastening elements 11 can be hooks for locking into corresponding notches on the mobile handset 20, or the fastening elements 11 can be notches for receiving hooks on the mobile handset 20.

A plastic film 12 can be coated or adhered to the inner surface of the casing device 10 for enhancing the casing device's structural strength and its robustness or external impact.

The casing device 10 as described has a member of advantages over prior arts. First, fine ceramics material allows the casing device 10 to have various colors that won't fade away after a period of usage. Secondly, the fine ceramics material offers superior hardness and smoothness to withstand scratches, abrasions, and smears. The casing device 10 therefore can still look like new even after extended period of usage.

It will be understood that each of the elements described above, or two or more together may also find a useful application in other types of methods differing from type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A casing device for a mobile handset, said casing device being made of a fine ceramics material molded into a single piece, said casing device having a plurality of fastening elements for joining said casing device to said mobile handset.

2. The casing device according to claim 1, wherein a plastic film is provided on the inner surface of said casing device.

3. The casing device according to claim 1, wherein said casing device completely encloses the body of said mobile handset.

4. The casing device according to claim 1, wherein said casing device encloses a part of the body of said mobile handset.

5. The casing device according to claim 1, wherein said fastening elements are hooks.

6. The casing device according to claim 1, wherein said fastening elements are notches.
